(19) United States
(12) Patent Application Publication
(10) Pub. No.: US 2008/0294433 A1
(43) Pub. Date: Nov. 27, 2008

(54) Automatic Text-Speech Mapping Tool

(76) Inventors: Minerva Yeung, Los Altos Hills, CA (US); Ping Du, Shanghai (CN); Nan N. Li, Shanghai (CN); Bian Wu, Shanghai (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/578,148

(22) PCT Filed: May 27, 2005
(86) PCT No.: PCT/CN05/00745

§ 371 Date: May 3, 2006

(51) Int. Cl. G10L 15/26

(52) U.S. Cl. 704/235

(57) ABSTRACT

A text-speech mapping method. Silence segments for incoming speech data are obtained. Incoming transcript data is preprocessed. The incoming transcript data comprises a written document of the speech data. Possible candidate sentence endpoints based on the silence segments are found. A best match sentence endpoint is selected based on a forced alignment score. The next sentence is set to begin immediately after the current sentence endpoint, and the process of finding candidate sentence endpoints, selecting the best match sentence endpoint, and setting the next sentence is repeated until all sentences for the incoming speech data are mapped. The process is repeated for each mapped sentence to provide word level mapping.

### BACKGROUND OF THE INVENTION

1. Field of the Invention

The present invention is generally related to speech processing. More particularly, the present invention is related to an automatic text-speech mapping tool.

2. Description

Conventional text-speech mapping tools process the text and audio/video manually. Thus, what is needed is an efficient and accurate method for automatic text-speech mapping.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a functional block diagram illustrating an exemplary system overview for sentence and word level mapping according to an embodiment of the present invention.

FIG. 2 is a flow diagram describing an exemplary method for automatic text-speech mapping according to an embodiment of the present invention.

FIG. 3 is a flow diagram describing an exemplary method for text preprocessing according to an embodiment of the present invention.

FIG. 4 is a flow diagram describing a method for forced alignment on candidate silence intervals according to an embodiment of the present invention.

FIG. 5 is a functional block diagram illustrating an exemplary forced alignment process according to an embodiment of the present invention.

FIGS. 6a, 6b, and 6c illustrate a process using forced alignment to determine a sentence ending according to an embodiment of the present invention.

FIG. 7 is a block diagram illustrating an exemplary computer system in which certain aspects of the invention may be implemented.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” or “in an embodiment” appearing in various places throughout the specification are not necessarily all referring to the same embodiment.

Embodiments of the present invention are directed to a method for automatic text-speech mapping. This is accomplished using VAD (Voice Activity Detection) and speech analysis. First an input transcript file is split into sentences. All words in the transcript are collected in a dictionary. VAD is then used to detect all the silence segments in the speech data. The silence segments in the speech data are candidates for starting and ending points of a sentence. Forced alignment is then used on all possible candidate places to provide sentence level mapping. The candidate with the maximum score is regarded as the best match. The process is then repeated for each sentence of the input transcript file to provide word level mapping for each sentence.

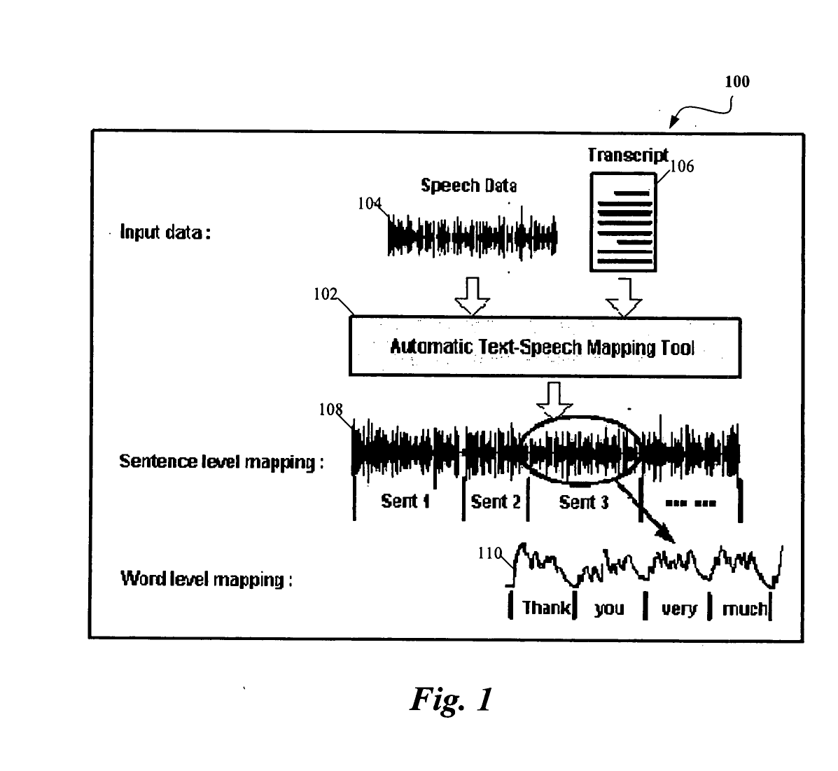

FIG. 1 is a functional block diagram 100 illustrating an exemplary system overview for sentence and word level mapping according to an embodiment of the present invention. Input data into an automatic text-speech mapping tool 102 includes speech data 104 and a transcript 106. Transcript 106 is a written document of speech data 104. Using VAD and speech analysis, automatic text-speech mapping tool 102 provides a sentence level mapping output 108 of each sentence in speech data 104 with transcript 106. Although not explicitly shown in FIG. 1, each sentence from sentence level mapping output 108 is used as input to automatic text-speech mapping tool, along with transcript 106, to obtain word level mapping output 110 for each word in each sentence of speech data 104.

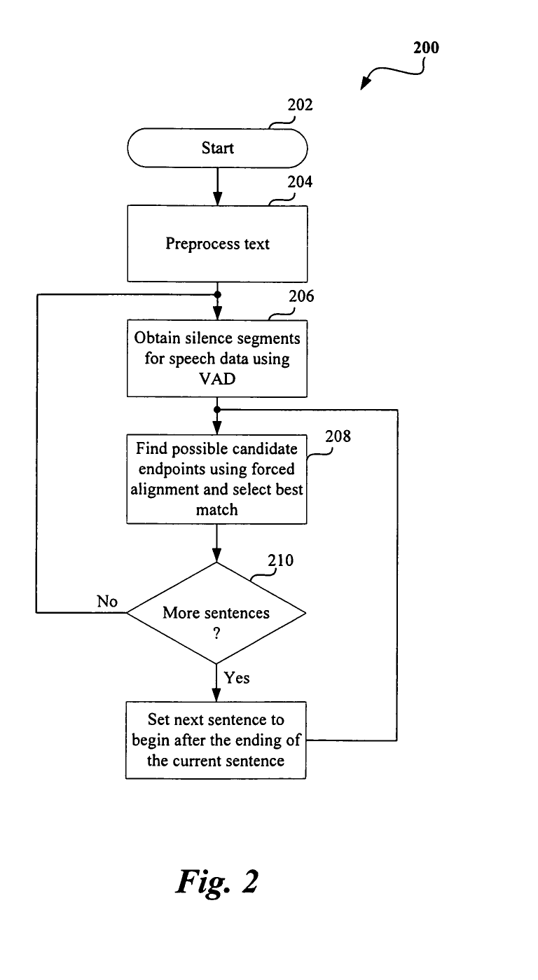

FIG. 2 is a flow diagram 200 describing an exemplary method for automatic text-speech mapping according to an embodiment of the present invention. The invention is not limited to the embodiment described herein with respect to flow diagram 200. Rather, it will be apparent to persons skilled in the relevant art(s) after reading the teachings provided herein that other functional flow diagrams are within the scope of the invention. The process begins with block 202, where the process immediately proceeds to block 204.

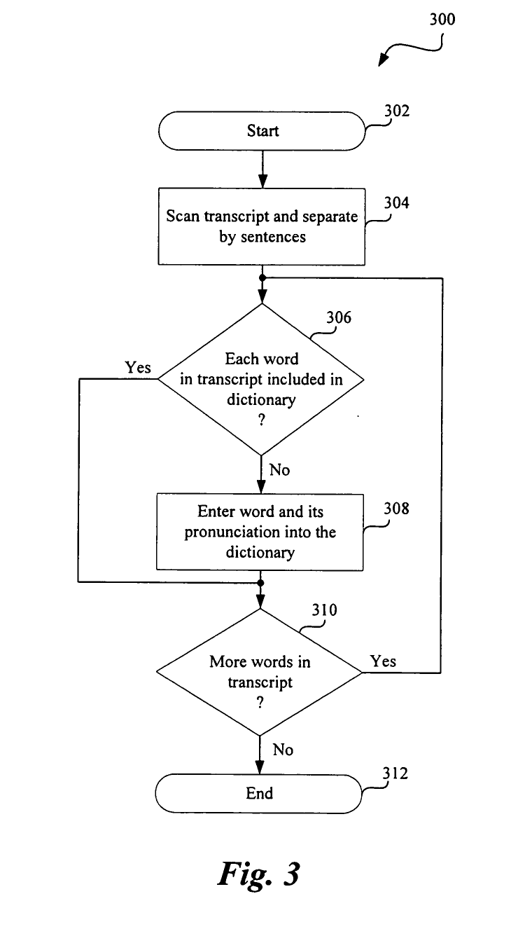

In block 204, text preprocessing is performed on a transcript comprising the speech data. A flow diagram describing a method for text preprocessing according to an embodiment of the present invention is described in detail below with reference to FIG. 3.

In block 206, voice activity detection (VAD) is used to detect silence segments on the speech data. VAD methods are well known in the relevant art(s).

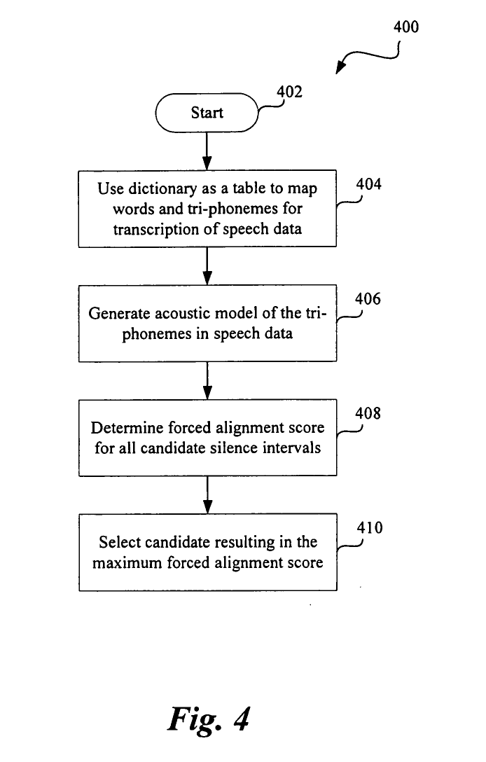

In block 208, forced alignment on possible candidate endpoints is performed. A flow diagram describing a method for forced alignment is described in detail below with reference to FIG. 4. The candidate endpoint with the maximum score is chosen as the best match, and therefore, the correct endpoint of the sentence.

In decision block 210, it is determined whether there are more sentences. If it is determined that there are more sentences, then the next sentence is set to begin immediately after the last sentence ends. The process then returns to block 208, to determine the next endpoint of the next sentence.

Returning to decision block 210, if it is determined that there are no more sentences in the speech data, then the process returns to block 206 where the process is repeated for word level mapping on each sentence determined above.

FIG. 3 is a flow diagram describing an exemplary method for text preprocessing according to an embodiment of the present invention. The invention is not limited to the embodiment described herein with respect to flow diagram 300. Rather, it will be apparent to persons skilled in the relevant art(s) after reading the teachings provided herein that other functional flow diagrams are within the scope of the invention. The process begins with block 302, where the process immediately proceeds to block 304.

In block 304, the entire transcript is scanned and separated by sentences. The process then proceeds to decision block 306.

In decision block 306, it is determined whether each word in the transcript is included in a dictionary to be used for forced alignment. The dictionary provides pronunciation information, including phoneme information, for each word in the dictionary. If a word is found that is not included in the dictionary, the process proceeds to block 308, where the word and its pronunciation are entered into the dictionary. The process then proceeds to decision block 310.

In decision block 310, it is determined whether there are more words in the transcript. If there are more words in the transcript, the process proceeds back to decision block 306 to determine if the next word in the transcript is found in the dictionary. If there are no more words in the transcript, then the process proceeds to block 312, where the process ends.

Returning to decision block 306, if it is determined that a word is already contained in the dictionary, then the process proceeds to decision block 310 to determine if there are more words in the transcript.

FIG. 4 is a flow diagram 400 describing a method for forced alignment on candidate silence intervals (also referred to as silent segments) according to an embodiment of the present invention. The invention is not limited to the embodiment described herein with respect to flow diagram 400. Rather, it will be apparent to persons skilled in the relevant art(s) after reading the teachings provided herein that other functional flow diagrams are within the scope of the invention. The process begins with block 402, where the process immediately proceeds to block 404.

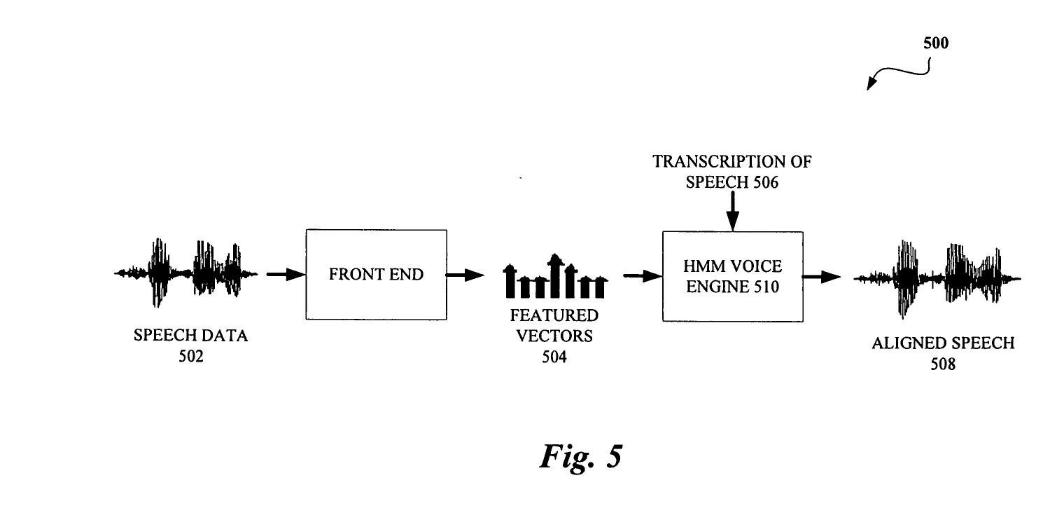

According to embodiments of the present invention, forced alignment may use an HMM (Hidden Markov Model) based voice engine 510 that accepts as input an acoustic model 504 that contains a set of possible words, phonemes of speech data 502 and an exact transcription 506 of what is being spoken in the speech data and provides as output aligned speech 508, as shown in FIG. 5. HMM is a very popular model used in speech technology and is well known to those skilled in the relevant art(s). Forced alignment then aligns the transcribed data with the speech data by identifying which parts of the speech data correspond to particular words in the transcription data.

In block 404, the dictionary developed in the text preprocessing block of FIG. 2 is used as a table to map words and tri-phonemes of the transcription of speech data. The process then proceeds to block 406.

In block 406, an acoustic model of the speech data is formed. The acoustic model records the acoustic features of each tri-phoneme for words in the input speech data. The process then proceeds to block 408.

In block 408, the similarity of the transcription speech features (obtained from the dictionary) with features in the acoustic model on each tri-phoneme level of the input speech data is determined using the HMM (Hidden Markov Model) voice engine to obtain possible endings for a given sentence. In one embodiment, at least four possible sentence endings are determined. Although at least four possible sentence endings are used in describing the present invention, the present invention is not limited to using at least four possible sentence endings. In fact, in other embodiments, more than four or less than four possible sentence endings may be used.

In block 410, the possible sentence ending resulting in the maximum forced alignment value is selected as the sentence ending. Note that any possible sentence ending resulting in a negative number is considered a failure and any possible sentence ending resulting in a positive number is considered a success, although, as indicated above, the possible sentence ending resulting in the maximum forced alignment value is selected. The beginning of the next sentence occurs after the current sentence ending.

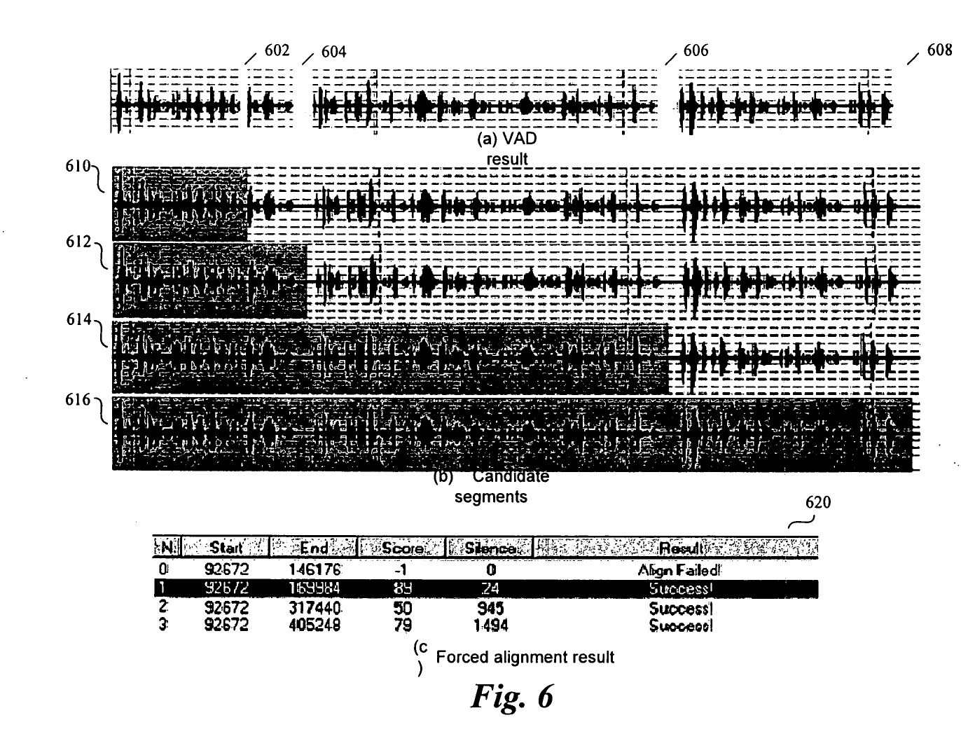

FIGS. 6a, 6b, and 6c illustrate a process using forced alignment to determine a sentence ending according to an embodiment of the present invention. FIG. 6a illustrates four silence segments (or intervals) 602, 604, 606, and 608 detected from the input speech data. FIG. 6b illustrates each of the four possible sentence candidates 610, 612, 614, and 616, highlighted in gray, that are used in the forced alignment determination of the sentence ending. Note that each possible sentence ending corresponds with a silence segment (602, 604, 606, and 608) shown in FIG. 6a. FIG. 6c illustrates a table 620 of forced alignment results for each of the four possible sentence candidates (610, 612, 614, and 616), indicated as N in table 620, with N=0 being the shortest possible sentence (610) and N=3 being the longest possible sentence (616). Note that shortest possible sentence 610 resulted in a forced alignment score of −1, which is indicated as an alignment failure. The remaining three candidate sentences (612, 614, and 616) each have a positive forced alignment score, resulting in a success. Sentence 612, illustrated as N=1 in table 620, has the maximum forced alignment score, and therefore, silence segment 604, shown in FIG. 8a, is chosen as the end of the sentence and the beginning of the next sentence immediately follows silence segment 604.

As previously indicated, the above process may be repeated for each defined sentence to obtain word level mapping for each defined sentence.

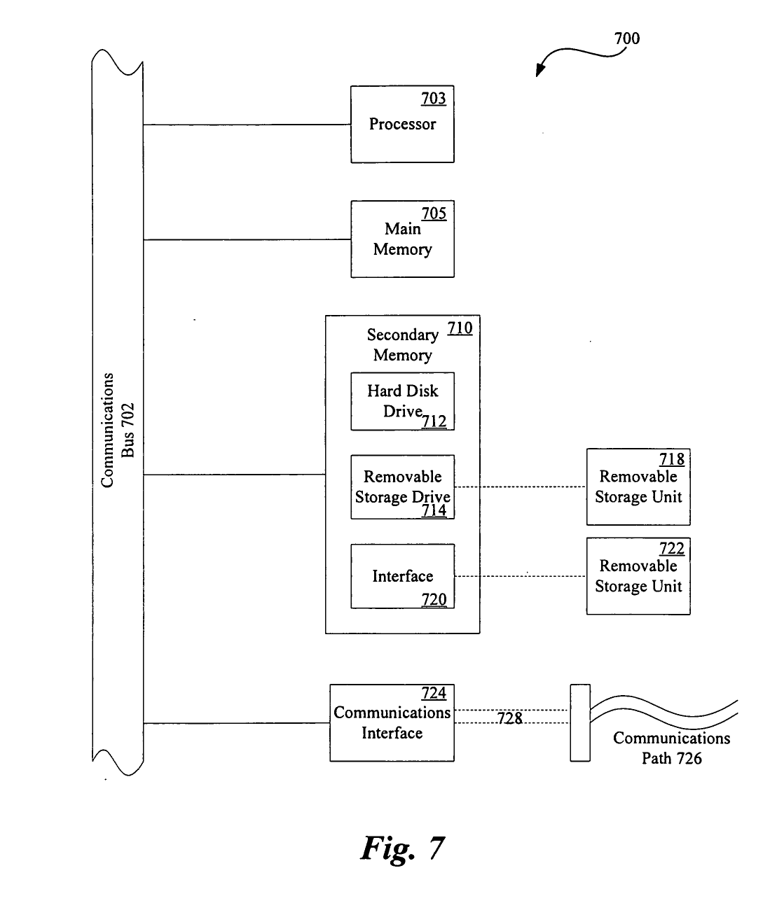

Embodiments of the present invention may be implemented using hardware, software, or a combination thereof and may be implemented in one or more computer systems or other processing systems. In fact, in one embodiment, the invention is directed toward one or more computer systems capable of carrying out the functionality described here. An example implementation of a computer system 700 is shown in FIG. 7. Various embodiments are described in terms of this exemplary computer system 700. After reading this description, it will be apparent to a person skilled in the relevant art how to implement the invention using other computer systems and/or computer architectures.

Computer system 700 includes one or more processors, such as processor 703. Processor 703 is capable of handling Wake-on-LAN technology. Processor 703 is connected to a communication bus 702. Computer system 700 also includes a main memory 705, preferably random access memory (RAM) or a derivative thereof (such as SRAM, DRAM, etc.), and may also include a secondary memory 710. Secondary memory 710 may include, for example, a hard disk drive 712 and/or a removable storage drive 714, representing a floppy disk drive, a magnetic tape drive, an optical disk drive, etc. Removable storage drive 714 reads from and/or writes to a removable storage unit 718 in a well-known manner. Removable storage unit 718 represents a floppy disk, magnetic tape, optical disk, etc., which is read by and written to by removable storage drive 714. As will be appreciated, removable storage unit 718 includes a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an EPROM (erasable programmable read-only memory), PROM (programmable read-only memory), or flash memory) and associated socket, and other removable storage units 722 and interfaces 720 which allow software and data to be transferred from removable storage unit 722 to computer system 700.

Computer system 700 may also include a communications interface 724. Communications interface 724 allows software and data to be transferred between computer system 700 and external devices. Examples of communications interface 724 may include a modem, a network interface (such as an Ethernet card), a communications port, a PCMCIA (personal computer memory card international association) slot and card, a wireless LAN (local area network) interface, etc. In one embodiment, communications interface 724 may be a network interface controller (NIC) capable of handling WoL technology. In this instance, when a WoL packet is received by communications interface 724, a system management interrupt (SMI) signal (not shown) is sent to processor 703 to begin the SMM manageability code for resetting computer 700. Software and data transferred via communications interface 724 are in the form of signals 728 which may be electronic, electromagnetic, optical or other signals capable of being received by communications interface 724. These signals 728 are provided to communications interface 724 via a communications path (i.e., channel) 726. Channel 726 carries signals 728 and may be implemented using wire or cable, fiber optics, a phone line, a cellular phone link, a wireless link, and other communications channels.

In this document, the term “computer program product” refers to removable storage units 718, 722, and signals 728. These computer program products are means for providing software to computer system 700. Embodiments of the invention are directed to such computer program products.

Computer programs (also called computer control logic) are stored in main memory 705, and/or secondary memory 710 and/or in computer program products. Computer programs may also be received via communications interface 724. Such computer programs, when executed, enable computer system 700 to perform the features of the present invention as discussed herein. In particular, the computer programs, when executed, enable processor 703 to perform the features of embodiments of the present invention. Accordingly, such computer programs represent controllers of computer system 700.

In an embodiment where the invention is implemented using software, the software may be stored in a computer program product and loaded into computer system 700 using removable storage drive 714, hard drive 712 or communications interface 724. The control logic (software), when executed by processor 703, causes processor 703 to perform the functions of the invention as described herein.

In another embodiment, the invention is implemented primarily in hardware using, for example, hardware components such as application specific integrated circuits (ASICs). Implementation of hardware state machine(s) so as to perform the functions described herein will be apparent to persons skilled in the relevant art(s). In yet another embodiment, the invention is implemented using a combination of both hardware and software.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What is claimed is:

1. A text-speech mapping method comprising:
obtaining silence segments for incoming speech data;
preprocessing incoming transcript data, wherein the transcript data comprises a written document of the speech data;
finding possible candidate sentence endpoints based on the silence segments;
selecting a best match sentence endpoint based on a forced alignment score; setting a next sentence to begin immediately after the sentence endpoint; and
repeating the finding, selecting and setting processes until all sentences for the incoming speech data are mapped.

2. The method of claim 1, wherein the preprocessing incoming transcript data comprises:
scanning the transcript data;
separating the scanned transcript data into sentences; and
placing each word from the scanned transcript data into a dictionary, if the word is not already in the dictionary.

3. The method of claim 2, wherein each word in the dictionary includes information on the pronunciation and phoneme of the word.

4. The method of claim 1, wherein the finding possible candidate sentence endpoints based on the silence segments comprises:
using a dictionary as a table to map words and tri-phonemes for the transcript data;
generating an acoustic model for the speech data, wherein the acoustic model records acoustic features of each tri-phoneme for words in the speech data; and
determining the similarity of the transcript data features obtained from the dictionary with the acoustic model features using a voice engine to find the possible candidate sentence endpoints.

5. The method of claim 4, wherein the voice engine is a HMM (Hidden Markov Model) voice engine.

6. The method of claim 1, wherein upon completion of mapping each sentence, the method further comprises:
obtaining silence segments for each mapped sentence, the method further including determining word level mapping for each mapped sentence, wherein the word level mapping comprises finding possible candidate word endpoints based on the silence segments;
selecting a best match word endpoint based on a forced alignment score;
setting a next word to begin immediately after the word endpoint; and
repeating the finding, selecting and setting processes until all words for the for the mapped sentence are mapped.

7. The method of claim 1, wherein voice activity detection is used to obtain silence segments for incoming speech data.

8. The method of claim 1, wherein a forced alignment process is used to find possible candidate sentence endpoints based on the silence segments, wherein the forced alignment process further includes selecting the best match sentence endpoint based on the forced alignment score.

9. A text-speech mapping system comprising:
a front end receiver to receive speech data, the front end including an acoustic module to model the speech data, wherein the acoustic module to record features of each tri-phoneme of each word in the speech data; and
a voice engine to receive a transcription of the speech data and to obtain features of each tri-phoneme of each word in the transcription from a dictionary, the voice engine to determine candidate sentence and word endings for aligning the speech data with the transcription of the speech data when performing sentence level mapping and word level mapping, respectively.

10. The system of claim 9, wherein the voice engine comprises a HMM (Hidden Markov Model) voice engine to perform alignment of the speech data with the transcription of the speech data.

11. A text-speech mapping tool comprising:
a front end receiver to receive speech data;
a text preprocessor to receive a transcript of the speech data;
a voice activity detector to determine silence segments representative of candidate sentences for the speech data; and
a forced alignment mechanism to determine the best candidate sentence and to align the best candidate sentences from the speech data with sentences from the transcript of the speech data to provide sentence level mapping.

12. The mapping tool of claim 11, wherein the voice activity detector to determine silence segments representative of candidate words for the speech data; and wherein the forced alignment mechanism to determine the best candidate word and to align the best candidate words from the sentences of the speech data with words from the sentences of the transcript of the speech data to provide word level mapping.

13. The mapping tool of claim 11, wherein the forced alignment mechanism further comprises an HMM (Hidden Markov Model) voice engine, wherein the HMM voice engine is used to determine a forced alignment score for candidate sentences and candidate words based on the silence segments, wherein the best candidate sentence and the best candidate word is based on the maximum forced alignment score.

14. An apparatus comprising:
an automatic text-speech mapping device, the automatic text-speech mapping device, the automatic text-speech mapping device including a processor and a storage device; and
a machine-readable medium having stored thereon sequences of instructions, which when read by the processor via the storage device, cause the automatic text-speech mapping device to perform sentence level mapping, wherein the instructions to perform sentence level mapping include:
obtaining silence segments for incoming speech data;
separating incoming transcript data into sentences, wherein the transcript data comprises a written document of the speech data;
finding possible candidate sentence endpoints based on the silence segments;
selecting a best match sentence endpoint based on a forced alignment score; setting a next sentence to begin immediately after the sentence endpoint; and
repeating the finding, selecting and setting processes until all sentences for the incoming speech data are mapped.

15. The apparatus of claim 14, wherein the machine-readable medium having stored thereon sequences of instructions, which when read by the processor via the storage device, cause the automatic text-speech mapping device to perform word level mapping, wherein the instructions to perform word level mapping include:
obtaining silence segments for each mapped sentence;
finding possible candidate word endpoints based on the silence segments;
selecting a best match word endpoint based on a forced alignment score;
setting a next word to begin immediately after the word endpoint; and
repeating the finding, selecting and setting processes until all words for the mapped sentence are mapped.

16. An article comprising: a storage medium having a plurality of machine accessible instructions, wherein when the instructions are executed by a processor, the instructions provide for obtaining silence segments for incoming speech data;
preprocessing incoming transcript data, wherein the transcript data comprises a written document of the speech data;
finding possible candidate sentence endpoints based on the silence segments;
selecting a best match sentence endpoint based on a forced alignment score; setting a next sentence to begin immediately after the sentence endpoint; and
repeating the finding, selecting and setting processes until all sentences for the incoming speech data are mapped.

17. The article of claim 16, wherein instructions for preprocessing incoming transcript data comprises instructions for:
scanning the transcript data;
separating the scanned transcript data into sentences; and
placing each word from the scanned transcript data into a dictionary, if the word is not already in the dictionary.

18. The article of claim 17, wherein each word in the dictionary includes information on the pronunciation and phoneme of the word.

19. The article of claim 16, wherein instructions for finding possible candidate sentence endpoints based on the silence segments comprises instructions for:
using a dictionary as a table to map words and tri-phonemes for the transcript data;
generating an acoustic model for the speech data, wherein the acoustic model records acoustic features of each tri-phoneme for words in the speech data; and
determining the similarity of the transcript data features obtained from the dictionary with the acoustic model features using a voice engine to find the possible candidate sentence endpoints.

20. The article of claim 19, wherein the voice engine is a HMM (Hidden Markov Model) voice engine.

21. The article of claim 16, wherein upon completion of mapping each sentence, the article further comprises instructions for:
obtaining silence segments for each mapped sentence, the article further including instructions for determining word level mapping for each mapped sentence, wherein the word level mapping comprises instructions for finding possible candidate word endpoints based on the silence segments;
selecting a best match word endpoint based on a forced alignment score;
setting a next word to begin immediately after the word endpoint; and
repeating the finding, selecting and setting processes until all words for the for the mapped sentence are mapped.

22. The article of claim 16, wherein voice activity detection is used to obtain silence segments for incoming speech data.

23. The article of claim 16, wherein a forced alignment process is used to find possible candidate sentence endpoints based on the silence segments, wherein the forced alignment process further includes instructions for selecting the best match sentence endpoint based on the forced alignment score.
